(19) United States
(12) Patent Application Publication
(10) Pub. No.: US 2005/0203762 A1
(43) Pub. Date: Sep. 15, 2005

(54) On-line merchant authorization

(76) Inventors: Jason L. Tebeau, Yorba Linda, CA (US); Dean F. Krekemeyer, Glendora, CA (US)

Correspondence Address: CHRISTIE, PARKER & HALE, LLP, PO BOX 7068, PASADENA, CA, 91109-7068, US

(21) Appl. No.: 10/822,402

(22) Filed: Apr. 12, 2004

Related U.S. Application Data
(60) Provisional application No. 60/462,264, filed on Apr. 12, 2003.

(51) Int. Cl. G06F 17/60

(52) U.S. Cl. 705/1

(57) ABSTRACT

Method and apparatus for on-line merchant authorization. An on-line merchant includes an authorization seal in the form of a graphic or logo on the on-line merchant's Web site. The authorization seal is granted by an unbiased third party. The third party authenticates the on-line merchant as an authorized on-line merchant for any brands the on-line merchant sells.

### CROSS-REFERENCE TO RELATED APPLICATION(S)

This application laims the priority benefit of U.S. Provisional Application No. 60/462,264, filed Apr. 12, 2003, which is incorporated herein by this reference.

### FIELD OF THE INVENTION

This invention pertains generally to on-line merchandising, and more specifically, to methods used by manufacturers to ensure that only authorized on-line merchants sell the manufacturers' products.

### BACKGROUND

Most consumer products are sold by merchants who buy products from manufacturers and then sell at the retail level to individual customers. Most manufacturers want to ensure that the merchants selling the manufacturer's products properly represent the manufacturer and its products to consumers. For example, a manufacturer of a shampoo may want its products to be sold only by certified cosmetologists operating in a salon and not by a drugstore chain. In addition, consumers may want to ensure that they buy products only from an authorized merchant. For example, some manufacturers will not honor a warranty on a product if the consumer has bought the product from an unauthorized merchant. Finally, merchants may want a manufacturer to assure the merchant that the merchant will not be competing with other sellers in the merchant's market niche. One of the ways a manufacturer can do this is to authorize only a single merchant for individual market niches. Therefore, manufacturers, consumers, and merchants all benefit from a manufacturer maintaining a set of merchants authorized to sell a manufacturer's products exclusively.

In a traditional “bricks and mortar” merchandising environment, a manufacturer can sometimes ensure that the manufacturer's products are being sold by authorized merchants. The merchant does so by policing the marketplace, looking for merchants that are selling the manufacturer's goods and verifying that the vendors are authorized to do so. As a retail establishment typically has a physical location, it was relatively easy in the past for a manufacturer to find out where its products were being sold at the retail level and to determine whether the merchant selling the products was authorized.

However, on-line merchants are much more difficult to police because the barriers to entering the on-line merchandising environment are relatively low. All an on-line merchant needs is a domain name, a Web server, and a place from which to ship products. As such, it is difficult for a manufacturer to police the on-line marketplace to determine if each on-line merchant selling the manufacturer's goods is authorized. Therefore, a need exists for a proactive method for a manufacturer to authorize on-line merchants. The present invention meets such a need.

### SUMMARY OF THE INVENTION

In one aspect of the invention, an on-line merchant includes a seal in the form or a graphic, logo, or insignia on the on-line merchant's Web site that is granted by an unbiased third party. The third party authenticates the on-line merchant as an authorized on-line merchant for brands the on-line merchant sells.

In another aspect of the invention, the seal that is granted to the on-line merchant for use on their Web site is a file which cannot easily be taken, reproduced, nor can the script which displays such a seal be used on any unauthorized site. An authorization server uses a database of authorized merchants to check and determine if the domain on which the seal is used is authorized. If the domain is not authorized, the page is reverted to a warning page served by the authorization server. If the domain is authorized, a seal is transmitted for display on the merchant's Web site.

In another aspect of the invention, when a Web page is loaded that contains the official authorized seller seal and code, the loading browser, such as Internet Explorer or Netscape Communicator, will check for the authorized code. If the code is present, a check mark or other icon will appear at the lower left corner of a browser window (just like the LOCK which appears when one is in SSL mode while checking out).

In another aspect of the invention, a manufacturer may approve and disapprove a brand that currently appears on their on-line merchant's authentication page. For example, if a on-line merchant is not adhering to price guidelines, the manufacturer can turn off their brand or set it to “disapproved” until the on-line merchant complies.

In another aspect of the invention, a resulting page which appears upon clicking by a consumer on the seal displays the approved brands for a particular domain. This information is obtained from an authorization database.

In another aspect of the invention, when a merchant signs up with an authorization site, the merchant discloses in a submission form whether they will be selling each brand on an on-line auction site. This is a second level of authentication that an operator of an authorization server confirms with a manufacturer. If the merchant is approved to sell that brand on an on-line auction site, the merchant's authentication page not only displays the domain or Web site they are approved to sell on, but the on-line auction site as well. The merchant is granted use of a second seal to display on their on-line auction pages. This seal uses the same technology as on the merchant's Web site, but modified slightly. The seal is still a generic script which does not allow for copying, but it does not check the domain on which it's displayed (since an on-line auction site's URLs may be different). The script that displays the seal looks for a “key” (a separate HTML code) and on-line auction user ID present on the on-line auction page. If the key is there and the on-line auction user ID is found in the authorization database, then the seal displays. The seal that is displayed on the on-line auction site page also says “Authorized On-Line Auction Seller” with a “Click to verify” link below. In this way, on-line auction site shoppers can see what brands a seller can sell on an on-line auction site and the seller's other web sites.

In another aspect of the invention, a conventional search engine is augmented by use of an authorization database. When a user searches for a product using a product description or brand name, the search engine uses the authorization database to filter a list or Web pages and only returns Web pages served by authorized on-line merchants. In one embodiment of such a search engine, a user selects an option to perform a search for all websites or pages including the product description or brand name, or may select an option to search an authorization database having only authorized on-line merchants.

### BRIEF DESCRIPTION OF THE DRAWINGS

These and other features, aspects, and advantages of the present invention will become better understood from the following description, appended claims, and accompanying drawings where:

FIG. 1 is a deployment diagram of an on-line merchant authorization system in accordance with one embodiment of the present invention;

FIG. 2 is a sequence diagram of an on-line authorization process in accordance with an embodiment of the present invention;

FIG. 3 is a Web site diagram of an authorization Web site in accordance with an embodiment of the present invention;

FIG. 4 is an architecture diagram of a data processing system suitable for use as an authorization host in accordance with an embodiment of the present invention; and

The Appendix includes screen captures from an on-line merchant's Web site and an authorization Web site in accordance with an embodiment of the present invention.

### DETAILED DESCRIPTION OF THE INVENTION

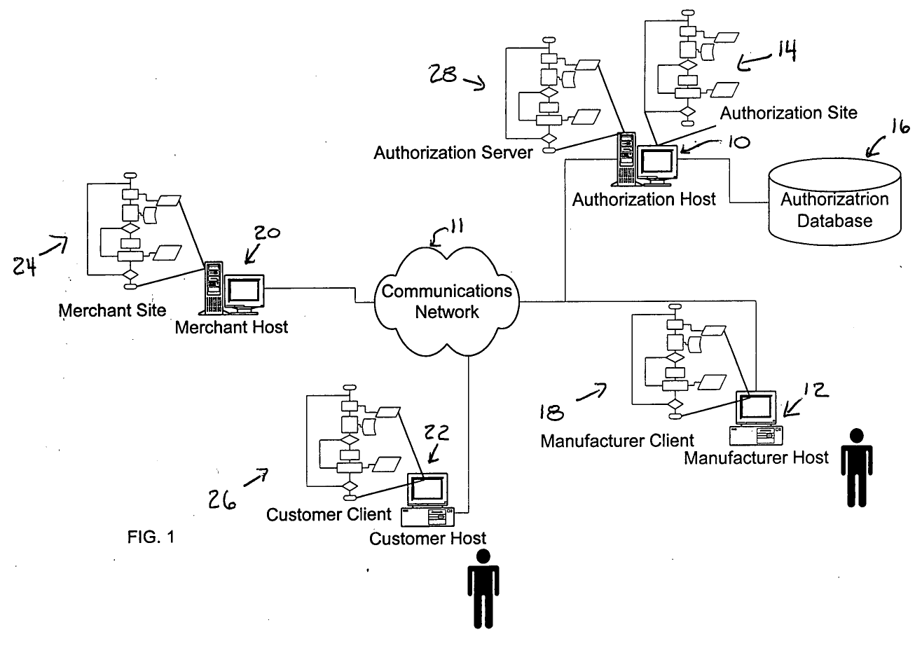

FIG. 1 is a deployment diagram of an on-line merchant authorization system in accordance with one embodiment of the invention. An authorization host 10 is coupled via a communications network 11 to a manufacturer's host 12. The authorization host hosts an authorization Web site that provides a user interface to an authorization database 16. A manufacturer uses a manufacturer client 18, such as a Web browser, hosted by the manufacturer host 10 to access the authorization Web site 14. The manufacturer uses the authorization Web site to enter authorization data into the authorization database 16. The authorization data includes information about on-line merchants that are authorized to represent a manufacturer's goods, such as information about which of the manufacturer's brands an on-line merchant is authorized to offer, and the domain name used by the on-line merchant.

An on-line merchant host 20 is coupled to the authorization host 10 and a customer host 22 via a communications network. The on-line merchant host hosts the on-line merchant's Web site 24 which may be accessed by a customer client 26, such as a browser, hosted by the customer host. When accessing the on-line merchant's Web site, the customer client requests and receives Web pages from the on-line merchant's Web site 24. These Web pages include a script that is executed by the customer client. The script instructs the customer client to request an authorization seal from the on-line merchant's Web site. In responding to the request, the on-line merchant's Web site 24 requests the authorization seal from the authorization server 28. As the request from the on-line merchant's Web site includes an IP address for the on-line merchant host, the authorization server 28 can verify that the on-line merchant host 20 is authorized to sell a manufacturer's brand by verifying the on-line merchant's IP address or domain name using the authorization database. As the authorization seal is actually a dynamically generated animation that is transmitted to the on-line merchant Web site and then to the customer client, the authorization seal cannot be readily replicated or counterfeited.

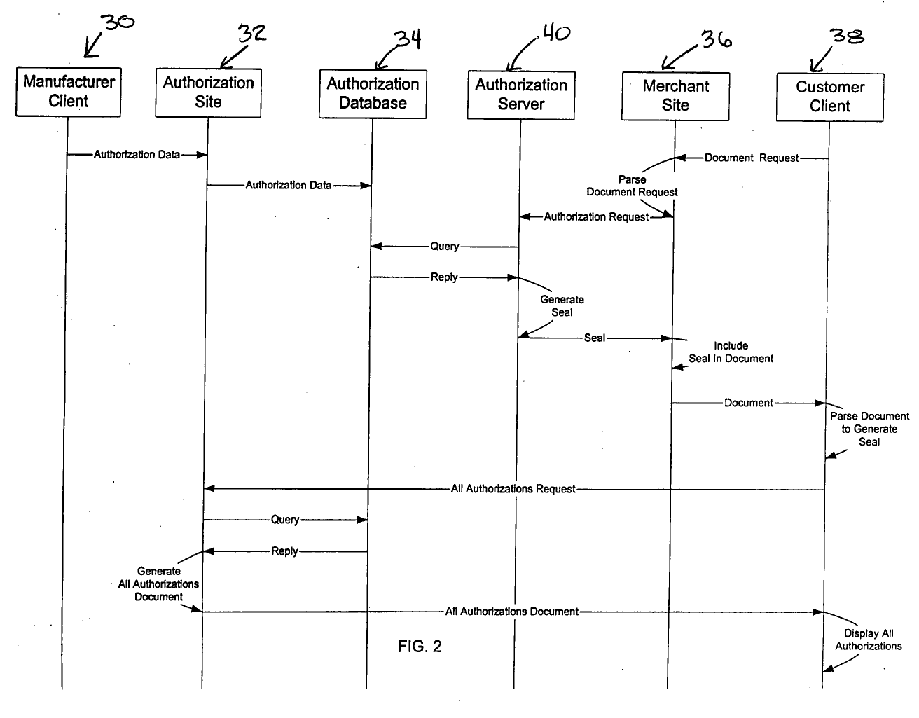

FIG. 2 is a sequence diagram of an on-line authorization process in accordance with an embodiment of the present invention. To enable an authorization process, a manufacturer uses a manufacturer client 30 to access an authorization Web site 32 and transmit authorization information to the authorization Web site. The authorization information or database 34 includes information about on-line merchants that are authorized by the manufacturer to sell the manufacturer's goods, such as information about which of the manufacturer's brands an on-line merchant is authorized to offer, and the domain name used by the on-line merchant.

When accessing the on-line merchant's Web site 36, the customer client 38 requests and receives electronic documents such as Web pages written in HTML from the on-line merchant's Web site 36. When the on-line merchant's Web site 36 receives the requests, the merchant site dynamically generates the electronic documents. As part of the document generation process, the on-line merchant Web site transmits a request for an authorization seal to the authorization server 40. Included in the request is the IP address or domain name of an on-line merchant host hosting the on-line merchant Web site. As the request from the on-line merchant's Web site includes an IP address for the on-line merchant host, the authorization server 40 can verify that the on-line merchant host is authorized to sell a manufacturer's brand by verifying the on-line merchant's IP address or domain name using the authorization database. If the on-line merchant is authorized to sell a particular product, the authorization seal is then generated by the authorization server and transmitted to the merchant Web site which then transmits the authorization seal to the customer client in an electronic document.

As an additional safeguard, the customer can select the authorization seal which causes a request to be transmitted to the authorization server by the customer client. The request includes the domain name of the merchant host. The authorization server uses the request to generate a Web page including all of an on-line merchant's authorizations. The Web page is then transmitted back to the customer client for display to the customer. In this way, a customer can independently verify an on-line merchant's authorizations.

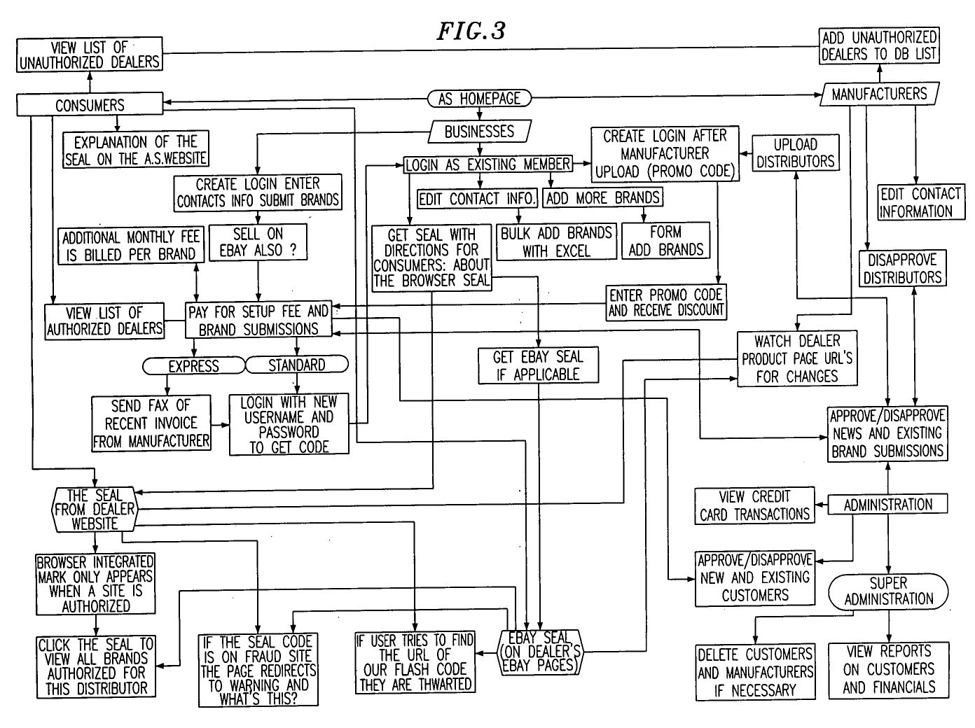

FIG. 3 is a Web site diagram of an authorization Web site in accordance with an embodiment of the present invention. In operation, an on-line merchant creates a login name and enters all contact information and the domain name of their Web site and then they enter the brands that they want to authorize and contact information for the brand manufacturers. The on-line merchant then pays for authorization setup and an initial fee per brand.

An on-line merchant's account can be either express or standard. An express account costs more at account setup time and provides the on-line merchant with faster brand authorizations. If the on-line merchant chooses an express account, they are instructed to send invoices from the manufacturers via FAX to an authorization server administrator. The FAX includes an on-line merchant's unique on-line merchant ID number received upon their initial registration.

Manufacturers specified by the on-line merchant are then notified and asked to authorize the submissions. Additionally, manufacturers have the option to sign up for free. They choose a login name and enter their contact information. After logging in, manufacturers can enter on-line merchants, to encourage their on-line merchants to get authorized. Manufacturers can also disapprove an on-line merchant for their brand at any time, subject to specified terms and conditions. An authorization server administrator manually authenticates submissions and logs in to enter the confirmations in the authorization online database.

On-line merchants receive an email from the system when each authorization is processed. In the email, they are instructed to log in to the authorization Web site and to get an authorization seal code. The authorization seal code page has a brief explanation of the authorization seal's relevance and instructions for placing it on their Web site. The authorization seal code is placed on the on-line merchant Web site and, since the on-line merchant's domain name is now in the authorization server's on-line database, the authorization seal appears on their web page. When the authorization seal is clicked, an authorization popup shows all authorizations associated with the on-line merchant's domain name. The authorization seal code also keeps count of page hits on the on-line merchant's web page and inserts the information into the authorization database. Once their initial payment has been processed and their account has thus been activated, authorized server customers can also submit additional brands for approval, at any time, by logging in to their authorization Web site account. The on-line merchant is billed monthly for each active brand submission, and on-line merchants have the option to cancel their brand authorizations at any time, subject to specified terms and conditions.

The authorization database contains information on all authenticated on-line merchants, manufacturers, and brands as well as transaction records, traffic history from on-line merchant sites and report data which charts the activity of authorizations on a daily, monthly and overall basis.

On the authorization Web site, consumers, on-line merchants, and manufacturers see repetitive examples of the authorization seal, with a short description of its significance and function.

Authorization server administrators and high level administrators can log in to the authorization Web site to view submissions, customer information and transaction information. Administrators have the ability to approve and disapprove on-line merchants and brand submissions at any time. High level administrators can view reports on on-line merchants and financials. They can also remove on-line merchants or manufacturers from the system if necessary.

The authorization seal may be a clickable Flash animation. When clicked, a new browser window pops open, revealing all of the brand approvals, pending approvals, suspended approvals, whether the on-line merchant is authorized to sell using an on-line auction, length of time as a seller of the merchant for a brand, and whether or not the on-line merchant is a drop shipment merchant or a stocking merchant or both, in the authorization database, which pertain to the on-line merchant's Web site. The source code which displays the authorization seal on the on-line merchant's Web site extracts the domain name of that Web site and searches for it in the authorization database. If the domain name is found in the authorization database, then the authorization seal is displayed. If the domain name is not found in the database, then the page which contains the authorization seal code will always redirect to the authorization Web site, whenever a customer views the Web page in their browser. If the domain name of the on-line merchant is in the authorization database, but the on-line merchant has not yet been authorized to sell any brands, then the authorization seal will simply not appear. Once this authorized on-line merchant gets authorized to sell a brand, the authorization seal will begin appearing.

If the on-line merchant's domain name is in the authorization database and the on-line merchant is authorized to sell a product from a manufacturer, the authorization seal code will display the authorization seal which prompts the customer to click the authorization seal, in order to view authorizations for a particular on-line merchant. When the authorization seal is clicked, a new window pops up, displaying a page from the authorization Web site, which queries the on-line database for information relating to that domain name. The display will show contact information for the on-line merchant who owns the domain name, along with any brand authorizations, pending authorizations, whether the on-line merchant is authorized to sell using an on-line auction, length of time as a merchant for a brand, and whether or not the on-line merchant is a drop shipment merchant or a stocking merchant or both, associated with that on-line merchant's account.

Additionally, the authorization seal code keeps count of page hits on the on-line merchant's Web page and inserts the information into the authorization database. The on-line merchant information can be viewed by high level authorization administrators of the authentication server.

The URL in the authorization seal script uses an IP address of the authorization server, rather than the domain name of the authorization server, thus hindering search engines from indexing the authorization server domain name in association with on-line merchant and manufacturer Web sites. So, a word, such as the domain name of the authorization server, when entered in a search engine query, will not produce a list of sites that bear the authorization seal. Thus, any list of authorized and unauthorized dealers will have to be obtained from the authorization Web site using the proprietary authorization database.

One use of the authorization database is to augment the services of a conventional search engine. In a conventional search engine, a user enters a brand name or a product description and receives a list of Web pages whose metadata or contents include the brand name or product description. An augmented search engine uses the authorization database to return a list of Web pages wherein only those Web pages hosted by an authorized on-line merchant are shown. In this way, the user can filter out unauthorized on-line merchants early on in an on-line product search.

It is difficult to copy the authorization seal. In addition, it is also very difficult to find the location of the authorization seal on the authentication server. Specifically, the URL of the authorization seal is not revealed in any of the source code that appears on an on-line merchant's site.

On the on-line merchant sites, the only visible code is an HTML <SCRIPT> tag containing a URL to a script on the authentication server. If someone puts this HTML <SCRIPT> tag on an unauthorized Web site, that is not in the authorization database, then the page on which they have placed the tag will automatically redirect to a warning page on the authorization Web site—whenever someone visits that unauthorized page.

Also, it is difficult for anyone to access the source code that is present on that script. The source code is protected by an automatic redirect, which disables the viewer from reading the source code. As such, there is no access to this file, which conceals the URL of the authorization seal. If, in their search for the URL of the authorization seal, someone enters the URL of the script file located on the authorization server, into a browser, one of two things will occur:
1. If the browser has JavaScript enabled, the JavaScript code on the page will redirect them immediately to an intermediate page, which loads very quickly and then redirects them again to a warning page on the authorization Web site.
2. If the browser does NOT have JavaScript enabled, an HTML <META> tag will immediately redirect them to an intermediate page, which loads very quickly and then redirects them again to a warning page on the authorization Web site.

Whenever the script is used on an unauthorized site, the domain name of that site is entered into the authorization database. In this way, authorization server administrators can view the number of times the authorization seal appeared on any given Web site.

When an on-line merchant signs up on an authorization Web site, they disclose in the submission form if they will be selling each brand in an on-line auction. This is a second level of authentication that an authorization server administrator confirms with the manufacturer. If the on-line merchant is approved to sell that brand in an on-line auction, their authentication page not only shows the domain name they are approved to sell from, but the on-line auction Web sites as well. The on-line merchant is granted the use of a second authorization seal to display on their on-line auction pages. This authorization seal uses the same technology as the Web site authorization seal, but the technology is modified slightly. The authorization seal is still a generic script which does not allow for copying, but it does not check the domain on which it's displayed (since an on-line auction sites URLs may be different). The script that displays the authorization seal downloads the on-line auction listing pages. A key and an on-line auction username is included in the HTML code for the on-line auction listing pages. There is a one-to-one mapping between keys and on-line auction usernames such that each key is unique to a on-line auction username and each on-line auction username is unique to a key. The script searches for the merchant's on-line auction username and key on the on-line auction listing page and attempts to match them with that on-line merchant's on-line auction usernames and keys in the authorization database. If they are there, the authorization seal displays. If not, the authorization seal does not display. The authorization seal that is displayed on the on-line auction page also says “Authorized On-line Merchant” with a “Click to verify” link below. Now on-line auction shoppers can see what brands an on-line merchant can sell in an on-line auction AND the on-line merchant's other Web sites.

The authorization Web site is served on the Microsoft .NET platform with a Microsoft SQLserver database. The source code for the site includes C++, HTML, JavaScript, and SQL (Structured Query Language.) Most of the pages on the authorization Web site contain information from the authorization database, which is inserted dynamically when the page is called by a browser. A secure gateway, for credit card transactions, is provided by a third party service. This is an industry standard architecture.

On-line merchant and manufacturer information is stored in a table which flags each entry respectively. The entry is also flagged “pending approval.” On-line merchants' brand submissions are entered into a separate table, flagged by the customer ID corresponding to the appropriate on-line merchant. Initially, each brand submission is additionally flagged as “pending approval.” After the brand submission is processed by an authorization server administrator, the submission is flagged appropriately as “approved” or “disapproved.”

When a manufacturer submits an on-line merchant to the authorization system, the on-line merchant is inserted into the system as an on-line merchant “pending approval” and the entry is flagged with a promotional code. When that on-line merchant logs in initially, they are asked to enter that promotional code, so that they can be quickly approved, since they are already in the system.

In another embodiment of an authorization Web site, a manufacturer pre-approves an on-line merchant. When the on-line merchant registers to be an authorized on-line merchant, the on-line merchant is given automatic approval by the authorization Web site without intervention by either an administrator of the authorization Web site or the manufacturer. In order to associate on-line merchants and manufacturers, a manufacturer's EIN is used.

In another embodiment of an authorization server, only on-line merchants with secure servers are allowed to obtain and use an authorization seal. In this embodiment, the authorization Web site requires that the on-line merchant enter a domain name or IP address of an SSL Web server. An authorization database administrator confirms that the proffered information is correct. Manufacturers and on-line merchants have the option to “bulk upload” to the system. The upload is handled by the HTML file upload feature. Manufacturers can upload a spreadsheet containing contact information for their on-line merchants. On-line merchants can upload a spreadsheet containing brand submissions, which is essentially a list of their manufacturers. Authorization server administrators will review these uploaded files, which are stored on the Web server, and enter the information into the authorization database via administrator level screens.

Manufacturers can log in and add “unauthorized” domains or on-line auction user IDs to the authorization on-line merchant list. This list is a searchable list stored in the authorization database. It is accessible from the authorization Web site home page which is open to the public. A customer can search by on-line auction user ID, URL, brand or product name. This list is also accessible by clicking on a manufacturer's seal located on a manufacturer's Web site. Manufacturers have complete editorial control over the contents of this list, so their message to consumers is customized.

Manufacturers can add a URL to watch. If the content on a specific URL changes, the manufacturer is emailed, letting them know there is a content change. This allows manufacturers to watch certain on-line merchants' pages if they are concerned about price changes. The code for this feature is in the authorization seal. This code checks the date, on the file, of the most recent modification and compares it with the last modification date, which is stored in the authorization database, when a manufacturer adds the URL to the system.

Manufacturers can place an authorized manufacturer seal on the manufacturer's Web site. When clicked, a window opens with a page that contains information about the manufacturer and explains the authorization service. This page can also display authorized and unauthorized dealers of this manufacturer's brands.

The authorization Web site home page has a search field that works like a regular search engine, but it produces results of “authorized” on-line merchants only. They display in a format based on a “Pay Per Click” method. On-line merchants pay to be listed at the top. This list of “authorized” merchants is stored in the authorization database. However, in contrast to conventional pay-per-click methods, an on-line merchant's listing will rotate in order thorough the listing with the rate of rotation dependent on the number of times a particular query is made. For example, a listing of on-line merchant's selling brand “A” may be rotated in the listing each time a user searches for on-line merchants selling that brand. In this way, an on-line merchant can be assured that they will have a fair opportunity to be listed first in the list of on-line merchants selling a particular brand. In addition, the on-line merchant may be charged on a “per-click” basis with the amount the merchant pays for being selected being proportional to the total number of queries that are made for the on-line merchant's brands.

A billing model allows a customer (an authorized dealer) who advertises with the authorization host to buy any keyword and is charged per click. If the customer puts the logo or insignia (described previously) on their home page, the present system automatically lowers their cost per click. The authorization host would allow any keyword to be purchased for exposure in the present system at the lower charge per click. Each time a shopper searches for a particular product, all authorized sites appear. If the search is done again for the same keyword, all dealers display again, but move up in the list like a conveyor belt. This way everyone gets equal exposure for the same search over time. These same dealers can pay a monthly fee to be listed at the very top of the page where only three companies at a time will display, for example. They will also rotate if there are four or more companies paying for the top position.

The present system uses a “keyword builder.” When a customer signs up with the authorization host and enters the keywords relevant to the customer's site, the present system builds pages that rank high on those keywords to be spidered by the search engines. When a shopper goes to a search engine, e.g., GOOGLE, and searches for the particular product, e.g., treadmills, a listing will appear that looks like this: “Buy Treadmills. For Authorized Dealers click here for a list of companies. Only buy products from authorized dealers to ensure full warranty and support from the manufacturer. www.authorizeddealer.com.” When the shopper clicks the link, they will land on the authorization host's web site and a list of all authorized treadmill dealers will appear.

The present system “feeds” the search engines with listings as customers sign up so they will receive traffic on their keywords. The authorization host will provide traffic to the customer via the major search engines and the authorization host's site.

Login security on the authorization Web site is achieved with server-side containing session-level variables. When a user logs in to the authorization Web site, a session variable is set to “true”. From that point on, until they log out, close their browser or their session times-out, they will be granted permission to view “internal” Web pages, by the security server-side include that lies in the head of each internal page. Obviously, on-line merchants are not granted access to administrator-level internal pages. Similarly, customers and administrator-level users are not granted access to super administrator-level internal pages. All of this is handled by the session variables in the internal page headers. On-line merchant login names and passwords are not valid when entered the administrator login page.

Authorization will have a mark that is integrated with commercial Web browsers, such as Microsoft's Internet Explorer, and appears on the browser interface. If the current Web site is registered as an authorized on-line merchant, the authorization mark will appear in the lower left hand corner of the browser interface, near the lock which appears when a Web site is on a secure Web server. This browser mark will only appear when a domain is registered as an authorized on-line merchant and it is “turned on” by the authorization seal which must appear on the on-line merchant's Web site. Customers can click on the Web site authorization seal to view the brands for which this domain is authorized. This mark is protected by Microsoft Certificate technology. No user installation is required as long as they have an up-to-date version of the browser.

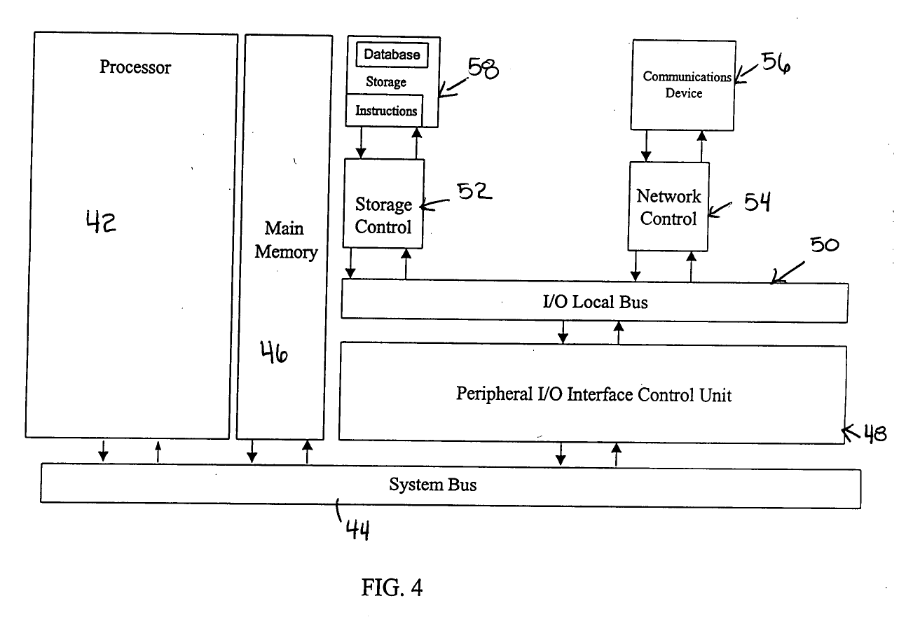

FIG. 4 is an architecture diagram of a data processing system suitable for use as an authorization host in accordance with an exemplary embodiment of the present invention. The data processing system includes a processor 42 coupled via a system bus 44 to a main memory 46 and an I/O control unit 48. The I/O control unit is operatively coupled via an I/O local bus 50 to a storage controller 52, and a network communications controller 54. A communications device 56 is operatively coupled to the network communications controller and is adapted to allow software objects hosted by the data processing system to communicate via a network with other software objects.

The storage controller is operatively coupled to a storage device 58. Computer program instructions implementing an authorization server are stored on the storage device until the processor retrieves the computer program instructions and stores them in the main memory. The processor then executes the computer program instructions stored in the main memory to implement the authorization server. The storage device may also be used to store authorization data in the form of an authorization database for use by the authorization server.

The Appendix includes screen captures from an authorization Web site in accordance with an exemplary embodiment of the present invention. The contents of Appendix A are hereby incorporated by reference as if stated fully herein.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supported by this application and the claims' equivalents rather than the foregoing description.

1. A computer implemented method of on-line merchant authorization comprising:
providing an authorization database of on-line merchants authorized to sell a particular brand of product offered for sale by a particular manufacturer;
providing a communications link for the manufacturer to enter authorization data in the authorization database, said authorization data including information relating to on-line merchants who have been authorized by the manufacturer to sell the manufacturer's particular brand of product on-line;
providing a communications link from an on-line search engine to both a customer host and the authorization database; and
providing a communications link in the search engine to select an option to search the authorization database having only authorized on-line merchants, so that a customer communicating with the search engine via the customer host can select the option to verify whether or not the on-line merchant host is authorized by the manufacturer to sell the particular brand of product on-line.

2. A computer implemented method of on-line merchant authorization comprising:
providing an authorization database of on-line merchants authorized to sell a particular brand of product offered for sale by a particular manufacturer;
providing a communications link for the manufacturer to enter authorization data in the authorization database, said authorization data including information relating to on-line merchants who are authorized to sell the manufacturers' particular brand of product on-line;
providing a communications link from an on-line merchant host to both a customer host and the authorization database, the on-line merchant host hosting an on-line merchant's website; and
providing authorization information to the merchant's website via the communications link from the authorization database to the on-line merchant host to verify for a customer accessing the on-line merchant's website whether or not the on-line merchant host is authorized by the manufacturer to sell the particular brand of product on-line.

3. The method according to claim 2 including:
providing an insignia to be visible to the customer on the on-line merchant's website; and
granting use of the insignia on the merchant's website via authentication controlled by a communications link from an authorization server controlled by the product's manufacturer,
in which use of the insignia is granted to verify authorization to sell the manufacturer's particular product on-line.

4. The method according to claim 3 including controlling the granting of use of the insignia via a system that protects against copying.

5. A computer implemented on-line merchant authorization system comprising:
an authorization database of on-line merchants authorized to sell a particular brand of product offered for sale by a particular manufacturer;
a communications link for the manufacturer to enter authorization data in the authorization database, said authorization data including information relating to on-line merchants who have been authorized by the manufacturer to sell the manufacturer's particular brand of product on-line;
a communications link from an on-line search engine to both a customer host and the authorization database; and
a communications link in the search engine to select an option to search the authorization database having only authorized on-line merchants, so that a customer communicating with the search engine via the customer host can select the option to verify whether or not the on-line merchant host is authorized by the manufacturer to sell the particular brand of product on-line.
